(19) United States
(12) Patent Application Publication
(10) Pub. No.: US 2025/0021266 A1
(43) Pub. Date: Jan. 16, 2025

(54) MEMORY SYSTEM, ACCESS CONTROL METHOD AND PROGRAM

(71) Applicant: NEC Platforms, Ltd., Kawasaki-shi (JP)

(72) Inventor: Takuma SATOU, Kanagawa (JP)

(73) Assignee: NEC Platforms, Ltd., Kawasaki-shi (JP)

(21) Appl. No.: 18/762,763

(22) Filed: Jul. 3, 2024

(30) Foreign Application Priority Data
Jul. 10, 2023 (JP) 2023-113102

(51) Int. Cl. G06F 3/06

(52) U.S. Cl. CPC G06F 3/0659; G06F 3/0604; G06F 3/0679

(57) ABSTRACT

A memory system includes: a non-volatile memory that includes a plurality of logical areas; and a controller that controls access to each logical area of the non-volatile memory. The controller includes an execution order control part that determines an execution order of a command received in accordance with a priority set in advance to a logical area specified by the command.

### CROSS REFERENCE TO RELATED APPLICATIONS

This application is based upon and claims the benefit of the priority of Japanese patent application No. 2023-113102, filed on Jul. 10, 2023, the disclosure of which is incorporated herein in its entirety by reference thereto.

The present disclosure relates to a memory system, an access control method and a program.

### BACKGROUND

For example, there is a memory system provided with a non-volatile memory such as an SSD (Solid State Drive) using NVMe (Non-Volatile Memory Express) as an interface protocol. Such a memory system logically divides (or partitions) its own storage area and uses it. Each storage area divided (or partitioned) logically is called NS (Name Space).

There is a technology to set a priority of an Atomic Write cancel for each NS from a host apparatus in order to adaptively control the performance of the cancel of write requests (write command) for the SSD, as a technology to improve the usability of an SSD. According to the technology disclosed in Patent Literature (PTL) 1, a priority for cancel is set for each NS, and a cancel processing manner is changed according to the priority set therefor.

[PTL 1] Japanese Unexamined Patent Application Publication No. 2017-107318 A

### SUMMARY

The following analysis is given by the present inventors.

Generally, in a memory system having SSDs using NVMe, etc., an NS is created separately for each purpose of information. Depending on the purpose, high-speed processing may or may not be required. For example, in an on-vehicle apparatus, driving information (current location and surrounding information) for automatic driving requires immediacy, even if processing of other information is postponed. On the other hand, the mileage and remaining fuel information can be put off until later. When using such a memory system in the on-vehicle apparatus, the information can be stored in different NSs for different purposes.

According to the technology disclosed in the PTL 1, the processing speed for one command varies according to the priority set in the NS. However, in such a memory system, commands are processed in an order in which they are issued. Therefore, even if information requiring immediacy is stored in an NS with a high priority, if a command for it is issued after a command for an NS to which information that does not require immediacy is stored, the former will not be executed until the latter has finished processing. Furthermore, the technology disclosed in PTL 1 only supports the cancel command. However, there are various commands from the host apparatus to the memory system, not only the cancel command.

In order to control an execution order of commands issued in succession, it is necessary to control an issuance order thereof to a non-volatile memory such as an NVMe SSD on the host apparatus side. This requires complex processing on the host apparatus side application.

Thus, currently, when multiple commands are issued in succession, the execution order of command cannot be properly controlled without forcing complicated processing on the host apparatus side. This causes latency in the processing in the memory system. This prevents faster processing in the memory system, and response performance is not fully maximized.

In view of the above-mentioned problems, it is an object of the present disclosure to provide an access technology to a memory that can improve performance without increasing a load on a host apparatus side.

According to a first aspect of the present disclosure, there is provided a memory system including:
a non-volatile memory that includes a plurality of logical areas; and
a controller that controls access to each logical area of the non-volatile memory.
   The controller includes an execution order control part that determines an execution order of a command received in accordance with a priority set in advance to a logical area specified by the command.

According to a second aspect of the present disclosure, there is provided an access control method to control access to each logical area in a non-volatile memory with a plurality of logical areas, including: determining an execution order of a command received in accordance with a priority set in advance to a logical area specified by the command.

According to a third aspect of the present disclosure, there is provided a program causes a computer of a controller in a non-volatile memory with a plurality of logical areas to execute:
processing of determining an execution order of a command received in accordance with a priority set in advance to a logical area specified by the command.

This program can be stored in a computer-readable storage medium. The storage medium may be a non-transitory one such as a semiconductor memory, a hard disk, a magnetic recording medium, an optical recording medium, and the like. The present invention can also be realized as a computer program product.

According to the present disclosure, performance of a memory system can be improved without increasing a load on a host apparatus side.

### BRIEF DESCRIPTION OF DRAWINGS

FIG. 1A is a diagram illustrating an example of a configuration of a memory system of an example embodiment according to a present disclosure.

FIG. 1B is a diagram illustrating an example of a hardware configuration of the memory system of the example embodiment according to the present disclosure.

FIG. 2A is a diagram illustrating an example of an information processing system of the example embodiment according to the present disclosure.

FIG. 2B is a diagram illustrating an example of a configuration of a memory system of the example embodiment according to the present disclosure.

FIG. 3A to FIG. 3C are diagrams illustrating examples of a create command, an MS Management command, and a command issued during operation, respectively, of the example embodiment according to the present disclosure.

FIG. 4A is a diagram illustrating an example of a MS table of the example embodiment according to the present disclosure.

FIG. 4B is a diagram illustrating an example of an execution order control of the example embodiment according to the present disclosure.

FIG. 5 is a flowchart illustrating a NS creation processing of the example embodiment according to the present disclosure.

FIG. 6 is a flowchart illustrating a command processing of the example embodiment according to the present disclosure.

FIG. 7A and FIG. 7B are command execution order of the example embodiment according to the present disclosure.

### EXAMPLE EMBODIMENTS

The following is an overview of an example embodiment of a present disclosure (hereinafter referred to as a present example embodiment) with reference to drawings. Note that reference signs in the drawings are for the sake of convenience for each element as an example to promote better understanding and are not intended to limit the present disclosure to a manner illustrated. Connection lines between blocks in the drawings referred to in the following description can be both bidirectional and unidirectional. A unidirectional arrow schematically shows the main flow of a signal (data) and does not exclude bidirectionality.

Input/output connection points of each block in the drawings have ports or interfaces, these are not illustrated. Further, in the following description, “A and/or B” means at least one of A and B.

### First Example Embodiment

Hereinafter, one example embodiment of the present disclosure (first example embodiment) will be described with reference to drawings.

A memory system 200 of a present example embodiment is a system that can control an execution order of commands in an SSD

(Solid State Drive). The SSD, here, is provided with a storage area configured with a non-volatile memory and uses, for example, a NVMe (Non-Volatile Memory Express). The memory system 200 operates as a storage device, stores received data and outputs the stored data upon request.

In the present example embodiment, the memory system 200 divides (or partitioned) a storage area (non-volatile memory) into a plurality of logical areas (Name space; NS), and sets priority (Priority) for each logical area in advance. Then, the memory system 200 executes commands received starting from the command which specifies NS with the highest priority.

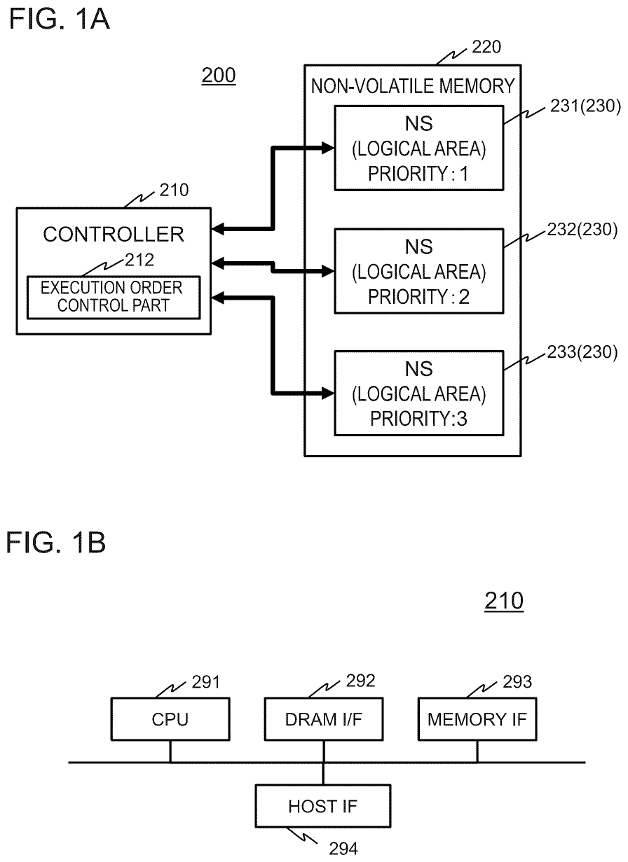

FIG. 1A is a configuration diagram illustrating an example of the memory system 200 of the present example embodiment. The memory system 200 is realized with, for example, an NVMe SSD and is provided with a controller 210, a non-volatile memory 220. The non-volatile memory 220 functions as a storage area.

The non-volatile memory 220 is realized by, for example, a NAND flash memory, etc. In the present example embodiment, the non-volatile memory 220 is logically divided (or partitioned) into a plurality of logical areas. Each logical area is referred to as a Name Space (NS), as described above. Each NS is assigned a priority in advance. The priority defines an execution order of commands, in advance.

FIG. 1 illustrates an example that the non-volatile memory 220 is provided with a NS 231, a NS 232 and a NS 233. The number of NSs can be a multiple and is not limited to three. Hereafter, when it is not necessary to distinguish between each NS, it will be represented by NS 230.

The controller 210 exchanges (or transmits to/receives from) data (signals) with a host apparatus that issues a command. The controller 210 also controls access and other operations for the non-volatile memory 220. The command received from the host apparatus includes information that specifies the NS 230 in which the data to be executed by the command is stored.

The controller 210 is provided with an execution order control part 212. The execution order control part 212 controls the order in which commands are executed (execution order). The execution order control part 212 of the present example embodiment determines the execution order of a command received according to the priority predetermined for the NS 230 specified by the command.

Controller 210 arranges an unexecuted command among commands received from the host apparatus in the execution queue in the order of execution. When the execution order control part 212 of the present example embodiment receives a new command from the host apparatus, it reorders the commands in the execution queue in the order of the priority of the NS 230 specified by the command received. Concretely, the execution order control part 212 rearranges commands so that the command that specifies NS 230 with the highest priority is executed first.

The controller 210 execute commands according to the execution queue rearranged by the execution order control part 212. Commands received from the host apparatus include, for example, read, erase, and write.

In addition, the controller 210 may perform an error detection and an error correction in the non-volatile memory 220. The controller 210 may perform a processing that prohibits a use of a memory block in which some defect has occurred and assigns a spare block (redundant block) instead. When a NAND flash memory is used for the non-volatile memory 220, the controller 210 may store the number of erase cycles for each memory block of the NAND flash memory and perform wear leveling of the number of rewrites.

As explained above, according to the present example embodiment, the priority of command execution is set in advance for each NS 230 on the memory system 200 side. Then, the memory system 200 controls the execution order of commands according to the priority set in the NS 230 specified by each command. In other words, on the memory system 200 side, the execution order of commands is rearranged so that the command that specifies NS 230 with higher priority is executed first.

This allows the memory system 200 of the present example embodiment to physically control processing performance on the memory system 200 side. In other words, according to the present example embodiment, in a memory system 200 in which a plurality of NSs 230 is set, an appropriate priority processing can be realized without any burden on a host apparatus side, i.e., a user.

This can suppress a degradation of NS performance caused by low-priority but heavy-load commands, and according to the present example embodiment, a memory system 200 with high efficiency, high speed, and immediate response can be realized. That is, a performance of the memory system can be maximized.

According to the present example embodiment, in a system where IO (Input/Output; command) with different performance requirements are mixed, processing of commands with a desired priority can be achieved with a simple configuration and at a lower cost compared to methods such as virtualization. For example, it is particularly useful in data centers and edge areas where various applications exist.

### Second Example Embodiment

Next, a second example embodiment of the present disclosure will be described. In the present example embodiment, when a controller 210 configures (creates) a logical area (NS 230) in a non-volatile memory 220 according to an instruction from the host apparatus, the controller 210 sets a priority for the NS 230.

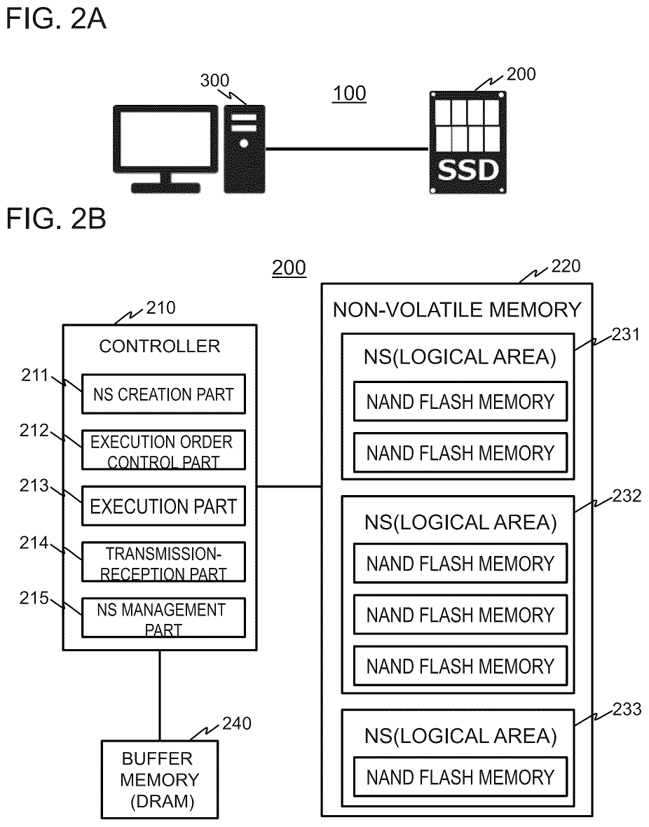

FIG. 2A is an overall configuration diagram of an information processing system 100 of the present example embodiment. The information processing system 100 of the present example embodiment is provided with a host apparatus 300 and a memory system 200. The memory system 200 is realized by an SSD or the like, as in the first example embodiment.

In the present example embodiment, the memory system 200 is hereinafter referred to as an SSD 200. For each function in the SSD 200, the same reference number are used for those that are the same as in the first embodiment.

The host apparatus 300 issues a command to the SSD 200. The host apparatus 300 is, for example, a PC (Personal Computer), a server, a storage, an Edge device, etc. The host apparatus 300 may be, but is not limited to, any device that can issue a command to the SSD 200 and can perform transmission-reception of data to and from the SSD 200.

In the present example embodiment, the host apparatus 300 is provided with an NVMe device driver, for example and issues various commands defined in the NVMe specification to the SSD 200. Concretely a command that the host apparatus 300 issues to the SSD 200 includes information identifying an NS 230 to be used.

The host apparatus 300 transmits a create command 310 to the SSD 200 when creating an NS 230 in the SSD 200. The create command(s) 310 is issued for the number of NS(s) 230 to be created. For example, if the host apparatus 300 creates three NS 230, three create commands 310 are issued, each having NSID 311.

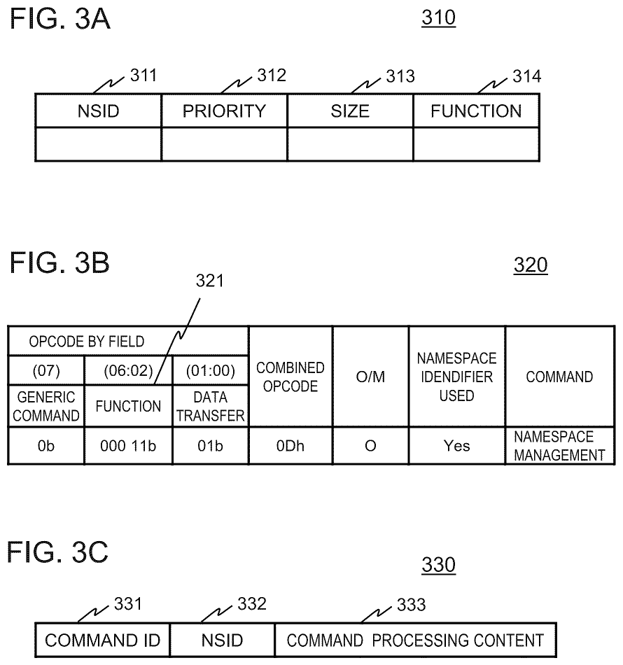

FIG. 3A illustrates an example of the create command 310. The create command 310 is provided with a NSID 311, a priority 312, a size 313, and a function 314. The NSID 311 is an identifier (ID) that can uniquely identify an NS 230 to be created. The priority 312 is a priority set to the NS 230. The size 313 is a size of a logical area of an NS to be created. The function 314 is information indicating a usage purpose of the NS 230.

For example, an existing NS management command may be used for setting a priority. FIG. 3B illustrates an example of an NS management command 320. In this case, a bit in a currently Reserve area in, for example, a Function Field 321 of an Operation Code (Opcode) in the NS management command 320 is used to set the priority of the NS in the SSD. A bit used to set the priority is not limited to this, and any reserved bit in an existing field in the command may be used.

A single create command 310 may include each of the above information for each NS 230, along with the number of divisions (or partitions).

A command 330 that the host apparatus 300 issues to the SSD 200 during operation includes a command ID 331, an NSID 332, and a command processing content 333, as illustrated in FIG. 3C. The command ID 331 is an identifier that uniquely identifies the command 330. The NSID 332 is an NSID of the NS 230 where the data to be executed (to be processed) is stored. The command processing content 333 includes a processing content of the command.

The SSD 200 has basically the same configurations as that of the first example embodiment. Hereinafter, the same name and the same reference number are applied to configurations having the same function as the first example embodiment.

As illustrated in FIG. 2B, the SSD 200 is provided with a controller 210, a non-volatile memory, and a buffer memory 240.

As in the first example embodiment, the controller 210 functions as an interface with the host apparatus 300 and controls access and other operations for the non-volatile memory 220. The controller 210 of the present example embodiment is provided with a NS creation part 211, an execution order control part 212, an execution part 213, a transmission-reception part 214, and an NS management part 215.

The transmission-reception part 214 transmits and receives data including commands, to and from the host apparatus 300.

The NS creation part 211 creates the number of NS 230 indicated, in the non-volatile memory 220 when it receives the create command 310 from the host apparatus 300. The NS creation part 211 sets a priority for each NS 230 at this time.

That is, the NS creation part 211 also functions as a priority setting part.

Concretely, the NS creation part 211 divides (or partitions) the non-volatile memory 220 into the indicated number of logical areas of a specified size and makes each of them the NS 230. Note that the NS creation part 211 deletes existing NSs before creating a new NS 230.

At this time, the NS creation part 211 creates an NS table 250. The NS table 250 includes each of the information specified by the create command 310 and the information that associates the NS 230 created with the physical area (referred to simply as a physical area). The NS table 250 generated is stored in the NS management part 215. The NS management part 215 is structured, for example, in a storage part of the controller 210. The NS management part 215 may be structured in the non-volatile memory 220.

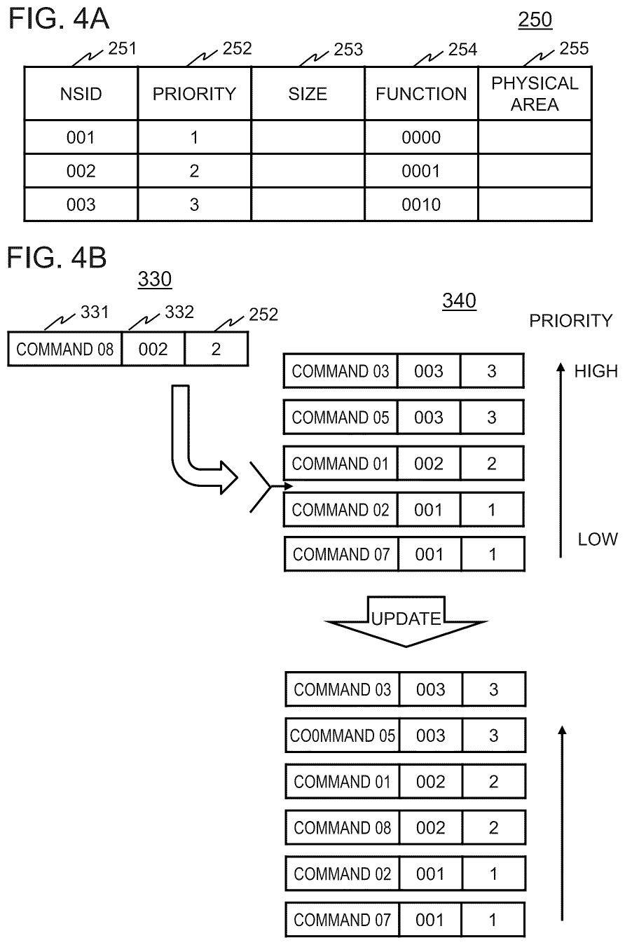

FIG. 4A illustrates an example of the NS table 250 generated by the NS creation part 211. For each NS 230 created, the NS table 250 is provided with a NSID 251 thereof, a priority 252 thereof, a size 253 thereof, a function 254 thereof, and a physical area 255 thereof.

In the NSID 251, the priority 252, the size 253 and the function 254, information with the same name in the create command 310 when generating the NS 230 are registered, respectively. In the physical area 255, information that associates each NS 230 created with a physical usage area in the non-volatile memory 220 is registered.

The execution order control part 212 controls an execution order of a command 330 issued by the host apparatus 300, as in the first example embodiment. When the command 330 is issued from the host apparatus 300, the execution order control part 212 queues it in an execution queue. At this time, the execution order control part 212 compares a priority of the NSID 332 (hereinafter referred to as the priority of the command) included in a command 330 that has been already queued with the priority of the command that is newly received and is to be queued, and inserts the command newly received into the execution queue so that commands are executed in the order of the priority.

When the execution order control part 212 receives a command 330 via the transmission-reception part 214, it extracts an NSID 332 included in the command 330. It refers to the NS table 250 and identifies the priority 252 associated with the NSID 251 that matches the NSID 332 extracted. Then, it inserts the command 330 in an execution queue. At this time, it may, for example, adds the priority 252 identified to the command 330.

The manner in which the execution order control part 212 adds the command 330 newly received to the execution queue is explained using FIG. 4B. Note that in FIG. 4B, the command processing content 333 in the command 330 is omitted. In FIG. 4B, a case in which a command 330 with the command ID 331 is “command 08” and the specified NSID 332 is “002” is received is illustrated as an example.

According to the manner above, the execution order control part 212 adds a priority 252 to the command 330 newly received. Here, NSID 332 is “002”, so the priority 252 is 2.

The execution order control part 212 then determines where in the execution queue 340, which is already ordered by priority, this command 330 should be inserted. Concretely, the execution order control part 212, for example, compares the priority 252 of the command in the execution queue with the priority 252 added to the command 330 newly received, starting with the first command in the execution queue. If the priority 252 added to the command 330 newly received is greater than the priority 252 added to a command 330 to be compared in the execution queue, the command 330 newly received is inserted immediately before the command 330 to be compared.

For example, in the example in FIG. 4B, the execution order control part 212 compares the priority of the command 330 in the execution queue 340, starting with the command having the highest priority. At the time of comparison with the command 330 whose command ID 331 is “command 02”, the priority 252 of the command 330 newly received becomes greater than the priority 252 of the command 330 of the comparison target for the first time. Therefore, the execution order control part 212 inserts the command 330 newly received immediately before the command 330 with “command 02” to update execution queue 340.

If the priority 252 added to the command 330 newly received is the lowest of the NS 230 priorities set for the SSD 200, the execution order control part 212 may add that command 330 newly received to the end of the execution queue 340 without the comparison process described above.

A manner for deciding the insertion position of the command 330 newly received is not limited to this. Comparisons may be made from the command at the end of the execution queue, or a bisection method or other existing sorting methods may be used.

The execution part 213 executes commands according to the execution queue decided by the execution order control part 212.

The transmission-reception part 214 controls transmission and reception of data to and from the host apparatus 300.

The NS management part 215 manages NS 230 as described above. In the present example embodiment, the NS management part 215 stores the NS table 250.

The non-volatile memory 220 is, for example, provided with a plurality of NAND flash memories. The non-volatile memory 220 is logically divided (or partitioned) according to an instruction from the controller 210, to create one or more logical areas. Each logical area is referred to as NS 230, as in the first example embodiment. A case where the non-volatile memory 220 is provided with a NS 231, a NS 232, and a NS 233 is illustrated here. The number of NSs and the number of NAND flash memories in each NS are not limited thereto.

The buffer memory 240 is configured with, for example, a DRAM (Dynamic Random Access Memory). The buffer memory 240 is used as a work area for the controller 210 in the present example embodiment.

### [Ns Creation Processing]

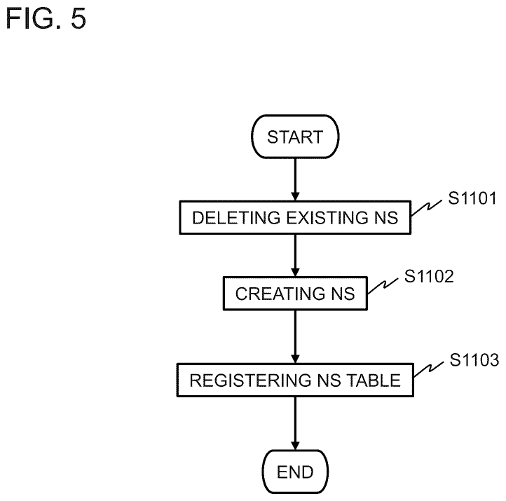

Next, a flow of an NS creation processing by the controller 210 according to the present example embodiment is described. FIG. 5 illustrates a processing flow of the NS creation processing of the present example embodiment. This processing is triggered when the NS creation part 211 receives a create command 310 from the host apparatus 300 via the transmission-reception part 214.

The NS creation part 211 deletes existing NS(s) 230 in the non-volatile memory 220 (step S1101). If the NS has not yet been created in the non-volatile memory 220, this processing need not be performed.

The NS creation part 211 creates the number of NS 230 specified by the host apparatus 300, each with the specified size (step S1102).

Then, the NS creation part 211 registers information of each NS 230 in the NS table 250 (step S1103) and terminates processing. Here, the NS creation part 211 registers a NSID 251, a priority 252, a size 253, a function 254, and a physical area 255, as described above.

### [Command Processing]

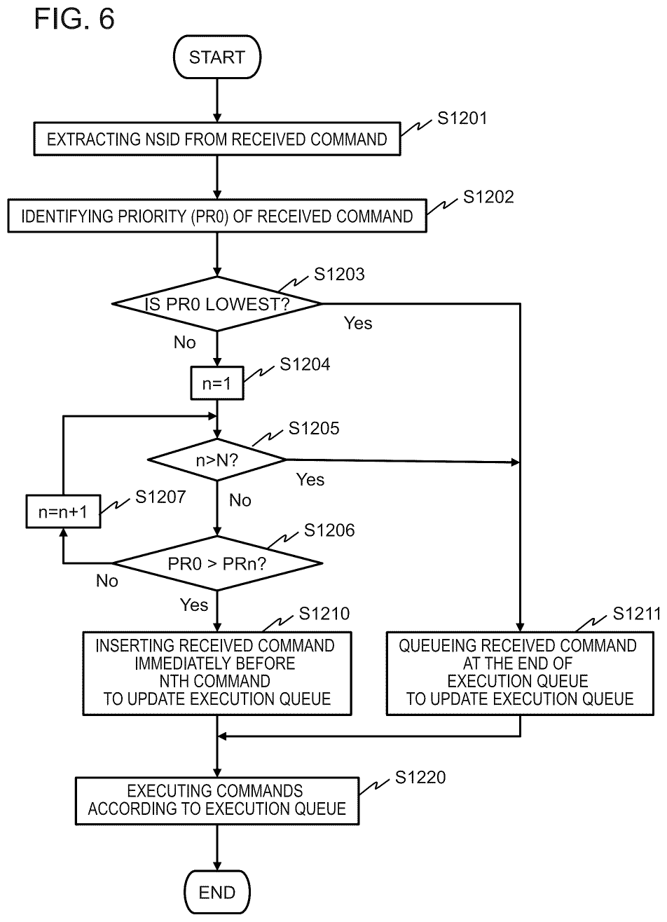

Next, a flow of a command processing when a command 330 is received from the host apparatus 300 after NS creation is described. FIG. 6 illustrates a processing flow of the command processing of the present example embodiment. This processing is performed by the execution order control part 212 and the execution part 213, each time a command 330 with a priority (with NSID 332) is received from the host apparatus 300 via the transmission-reception part 214.

The execution order control part 212 interprets the command 330 received and extracts an NSID 332 specified therein (step S1201).

The execution order control part 212 refers to the NS table 250 and identifies the priority 252 that is registered corresponding to the NSID 251 that matches the NSID 332 extracted (step S1202). The priority 252 identified here is denoted as PR0.

The execution order control part 212 determines whether or not the priority 252 (PR0) identified is the lowest of the priorities set in the NS 230 (step S1203). If lowest (S1203: Yes), the execution order control part 212 queues the command 330 received at the end of an execution queue 340 to update the execution queue 340 (step S1211).

Otherwise (S1203: No), the execution order control part 212 compares the priority 252 identified with a priority of the command in the execution queue 340, starting with the first command therein, decides where to insert the command 330 received, and updates the execution queue 340. The method is described in detail below. Here, a case in which N commands are queued is illustrated as an example. The nth command from the beginning of the execution order in the execution queue 340 is called a “nth command”.

The execution order control part 212 initializes a counter n (n=1) (step S1204). If n is greater than N (S1205: Yes), the execution order control part 212 moves to step S1211.

Otherwise (S1205: No), the execution order control part 212 compares the priority (PR0) identified with the priority (PRn) of the nth command from the beginning. Here, the execution order control part 212 determines whether or not PR0 is higher (greater) than PRn (step S1206).

If PR0 is higher than PRn (S1206: Yes), the execution order control part 212 inserts the command 330 received immediately before the nth command to update the execution queue (step S1210).

On the other hand, if PR0 is less than or equal to PRn (S1206: No), the execution order control part 212 increments n by 1 (step S1207) and returns to step S1205 to repeat processing. Until n exceeds N, the execution order control part 212 compares the priority (PR0) identified with the priority of the next command in execution order.

When the execution queue 340 is updated, the execution part 213 executes commands from the beginning of the execution queue 340 (step S1220) and terminates processing.

As an actual example of the above example embodiment, the following is an explanation of the execution order when a write command and a read command are issued from the host apparatus 300.

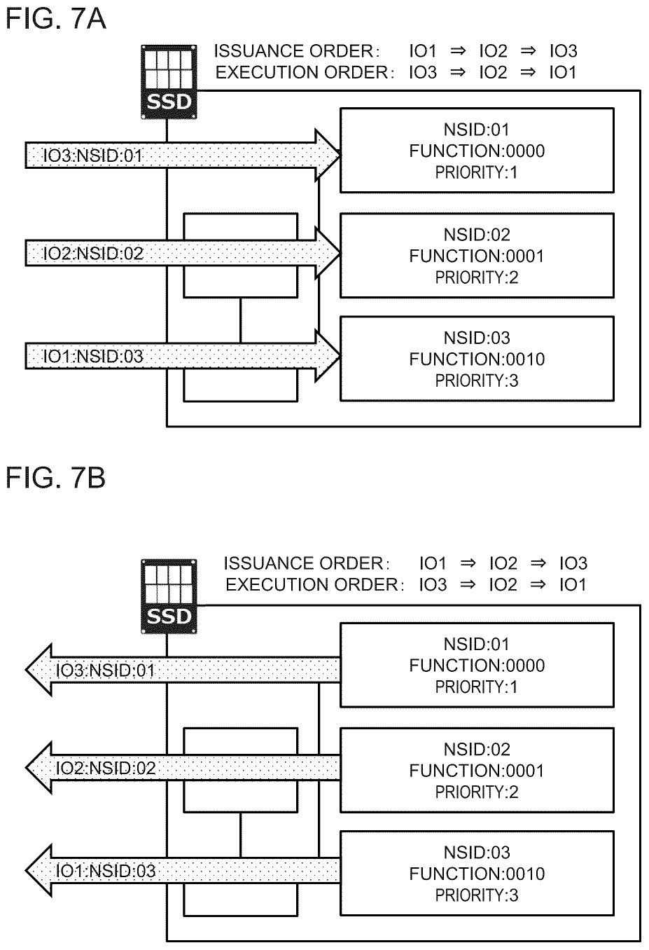

For example, when three write commands are issued, the order in which they are issued and the order in which they are actually executed are described. FIG. 7A illustrates an order of execution. Here, a case in which three write commands I01, I02, and I03 are issued in this order, and NSID: 01, NSID: 02, and NSID: 03 are specified as NS 230 to be executed, respectively is illustrated as an example.

In this case, the priority of NS specified in each write command is 1, 2, and 3, respectively, according to the NS table 250 in FIG. 4A, so the order of execution is I03, I02, and I01.

Similarly, FIG. 7B illustrates an execution order when three read commands I01, I02, and I03 are issued in this order. As illustrated in this drawing, a case in which NS specified by each read command 101, 102, and 103 are NSID: 01, NSID: 02, and NSID: 03, respectively, as above, is explained as an example. In this case, the order of execution is I03, I02, and I01.

As explained above, the information processing system 100 of the present example embodiment sets the priority of execution for each NS 230 in the memory system 200. Therefore, by simply specifying an NS 230 to be executed in a command 330 on the host apparatus 300 side, each command is processed at a desired priority, even if multiple commands conflict. Therefore, according to the present example embodiment it is obtained the same effect as in the first example embodiment.

Furthermore, in the present example embodiment, a priority of each NS 230 is specified from the host apparatus 300 when the NS 230 is created. Since each NS 230 can be created for different purposes, it can be configured so that commands are processed at the user's desired priority for each purpose.

Thus, the present example embodiment can realize a memory system 200 with high efficiency, high speed, and immediate response.

### [Hardware Configuration]

FIG. 1B illustrates an example of a hardware configuration of the controller 210 in each of the above example embodiments. The controller 210 may be provided with a CPU (Central Processing Unit) 291, a DRAM interface (I/F) 292, a memory I/F 293, and a host I/F 294, which are interconnected by an internal bus, as illustrated in FIG. 1A.

The CPU 291 is a processor that realizes each of the above functions of the controller 210. The CPU 291, for example, loads a program such as firmware stored in the non-volatile memory 220 or the like onto RAM such as DRAM and executes it to realize each of the above functions.

The DRAM I/F 292, the memory I/F 293 and the host I/F 294 control transmitting and receiving of data to and from a RAM such as a DRAM, the non-volatile memory 220 and the host apparatus 300, respectively.

Each function realized by the CPU 291, the DRAM I/F 292, the memory I/F 293, and the host I/F 294 may be respectively realized by dedicated hardware. They may be implemented, for example, by dedicated integrated circuits (IC) for each processing, application specific integrated circuits (ASIC), system-on-chips (SOC), field programmable gate arrays (FPGA), etc.

### Variation Example 1

In each of the above example embodiments, a case where the memory system 200 is an SSD is explained as an example. However, the memory system 200 is not limited to the SSD. The memory system 200 can be any storage device with a non-volatile memory that is accessible via the Nonvolatile Memory Express (NVMe) protocol. For example, it may be a flash device.

In each of the above embodiments, a case where a NAND memory is used as the non-volatile memory 220 provided by the memory system 200. is explained as an example. However, the non-volatile memory 220 is not limited thereto. The non-volatile memory 220 may be various other as non-volatile memories, such a MRAM (Magnetoresistive Random Access Memory), a PRAM (Phase change Random Access Memory), a ReRAM (Resistive Random Access Memory), or a FeRAM (Ferroelectric Random Access Memory), for example.

### Variation Example 2

An NVMe device can have a plurality of controllers, and the NS 230 is assigned to each controller. In each of the above example embodiments, a case in which there is only one controller 210 in the memory system 200 is explained as an example, but there may be a plurality of controllers 210. In this case, in each controller 210, a priority of a command for the NS 230 assigned may be controlled by a manner according to each of the above example embodiment.

### Variation Example 3

In each of the above example embodiments, a command 330 to be executed is provided with an NSID 332. However, it is not limited thereto. For example, if a function is defined for each NS 230, the function may be specified.

On the host apparatus 300 side, a table may be provided that associates functions with NS 230 (NSID). In this case, a user specifies the function when issuing the command. Then, the host apparatus 300 may refer to the table, identify the NSID corresponding to the function specified, and include it in the command to be issued.

Alternatively, a function may be predefined for each command. In this case, the host apparatus 300 may be configured to identify the function for each command, refer to the table to identify the NSID corresponding thereto, and issue a command 330.

### Variation Example 4

Instead of the NSID 332, a priority may be specified in a command 330. In this case, the execution order control part 212 extracts the priority specified from the command 330 and decides the insertion position of the command 330 into the execution queue 340 according to the priority extracted. The execution order control part 212 or the execution part 213 refers to the NS table 250, identifies the NSID 251 corresponding to a priority 252 that matches the priority extracted, and decides the NS 230 to be processed.

### Variation Example 5

In each of the above example embodiments, a different priority 252 is set for each NS 230, but is not limited thereto. For example, the same priority 252 may be set for multiple NSs 230.

### Variation Example 6

In each of the above example embodiments, if correspondence information between a logical area and a physical area is stored in advance, information identifying the logical area may be stored in the NS table 250 instead of the physical area 255.

### Variation Example 7

In each of the above example embodiments, the host apparatus 300 and the memory system (SSD) 200 are independent devices, but are not limited thereto. The memory system 200 may be incorporated in the host apparatus 300 as a storage device thereof.

In a plurality of flowcharts (sequence diagram) used in the above description, a plurality of steps (processes) are described in order, but the order of performing of the steps performed in each example embodiment is not limited to the described order. In each example embodiment, the illustrated order of processes can be changed as far as there is no problem with regard to processing contents, such as a change in which respective processes are executed in parallel, for example.

The various programs such as a program that are stored in the non-volatile memory 220 and realize the functions of the controller 210 may provide as a program product recorded in a non-transitory computer readable storage medium. These can be used to store various programs recorded on a non-transitory computer readable storage medium for medium-to-long term.

Although the present disclosure has been described with reference to the example embodiments and variation examples, the present disclosure is not limited thereto. Various modifications that can be understood by those skilled in the art can be made to the configurations and details of the present invention within the scope of the present invention. Each example embodiment and variation example can be combined with other example embodiments and/or variation examples as appropriate. Note that the network configuration and the configuration of each element illustrated in each drawing are examples to promote better understanding of the present disclosure and are not limited to the configurations illustrated in these drawings.

Finally, preferred modes of the present disclosure will be summarized. The whole or part of example embodiments disclosed above can be described as, but not limited thereto, the following Supplementary Notes.

### Supplementary Note 1

A memory system includes:
a non-volatile memory that includes a plurality of logical areas; and
a controller that controls access to each logical area of the non-volatile memory.

The controller includes an execution order control part that determines an execution order of a command received in accordance with a priority set in advance to a logical area specified by the command.

### Supplementary Note 2

The memory system described in supplementary note 1, preferably further includes:
an execution part that executes commands according to an execution queue in which the commands are queued in the execution order.

The execution order control part preferably rearranges the execution queue, each time a new command is received, in a descending order of the priority of the logical area specified by the new command.

### Supplementary Note 3

In the memory system described in supplementary note 1 or 2, it is preferable that the controller further includes a priority setting part that sets the priority, when dividing the non-volatile memory into the plurality of logical areas.

### Supplementary Note 4

In the memory system described in any one of supplementary notes 1 to 3, it is preferable that each of the plurality of logical areas is set for each purpose.

### Supplementary Note 5

An access control method to control access to each logical area in a non-volatile memory with a plurality of logical areas, includes: determining an execution order of a command received in accordance with a priority set in advance to a logical area specified by the command.

### Supplementary Note 6

A program causes a computer of a controller in a non-volatile memory with a plurality of logical areas to execute:
processing of determining an execution order of a command received in accordance with a priority set in advance to a logical area specified by the command.

The above supplementary notes 5 and 6 can be expanded in the same way as supplementary note 1 is expanded to supplementary note 2 to 4.

The disclosure of the PTL 1 is incorporated herein by reference thereto.

Variations and adjustments of the example embodiments and/or variation examples are possible within the scope of the overall disclosure (including the claims) based on the basic technical concept.

Various combinations and selections of examples and disclosed elements (including the elements in each of the claims, examples, drawings, etc.) are possible within the scope of the claims of the present application. That is, the present disclosure includes various variations and modifications that could be made by those skilled in the art according to the overall disclosure including the claims and the technical concept. In particular, the numerical range described in this document should be interpreted as specifically describing any numerical value or subrange that falls within that range, even if not otherwise stated.

What is claimed is:

1. A memory system, comprising:
a non-volatile memory that comprises a plurality of logical areas; and
a controller that controls access to each logical area of the non-volatile memory,
wherein
the controller determines an execution order of a command received in accordance with a priority set in advance to a logical area specified by the command.

2. The memory system according to claim 1, wherein
the controller further
executes commands according to an execution queue in which the commands are queued in the execution order, and
rearranges the execution queue, each time a new command is received, in a descending order of the priority of the logical area specified by the new command.

3. The memory system according to claim 1, wherein
the controller further sets the priority, when dividing the non-volatile memory into the plurality of logical areas.

4. The memory system according to claim 1, wherein
each of the plurality of logical areas is set for each purpose.

5. The memory system according to claim 2, wherein
the controller further sets the priority, when dividing the non-volatile memory into the plurality of logical areas.

6. The memory system according to claim 2, wherein
each of the plurality of logical areas is set for each purpose.

7. The memory system according to claim 3, wherein
each of the plurality of logical areas is set for each purpose.

8. The memory system according to claim 5, wherein
each of the plurality of logical areas is set for each purpose.

9. An access control method to control access to each logical area in a non-volatile memory with a plurality of logical areas, comprising:
determining an execution order of a command received in accordance with a priority set in advance to a logical area specified by the command.

10. The access control method according to claim 9, further comprising:
rearranging an execution queue, each time a new command is received, in a descending order of the priority of the logical area specified by the new command, the execution queue being a queue in which the commands are queued in the execution order; and
executing commands according to the execution queue.

11. The access control method according to claim 9, wherein
the priority is set when dividing the non-volatile memory into the plurality of logical areas.

12. The access control method according to claim 10, wherein
the priority is set when dividing the non-volatile memory into the plurality of logical areas.

13. The access control method according to claim 9, wherein
each of the plurality of logical areas is set for each purpose.

14. The access control method according to claim 10, wherein
each of the plurality of logical areas is set for each purpose.

15. The access control method according to claim 11, wherein
each of the plurality of logical areas is set for each purpose.

16. The access control method according to claim 12, wherein
each of the plurality of logical areas is set for each purpose.

17. A non-transitory computer-readable medium storing a program causing a computer of a controller in a non-volatile memory with a plurality of logical areas to execute:
processing of determining an execution order of a command received in accordance with a priority set in advance to a logical area specified by the command.

18. The non-transitory computer-readable medium according to claim 17, further to execute:
processing of rearranging an execution queue, each time a new command is received, in a descending order of the priority of the logical area specified by the new command, the execution queue being a queue in which the commands are queued in the execution order; and
processing of executing commands according to the execution queue.

19. The non-transitory computer-readable medium according to claim 17, wherein
the priority is set when dividing the non-volatile memory into the plurality of logical areas.

20. The non-transitory computer-readable medium according to claim 17, wherein
each of the plurality of logical areas is set for each purpose.
